(19) United States
(12) Patent Application Publication
(10) Pub. No.: US 2017/0371433 A1
(43) Pub. Date: Dec. 28, 2017

(54) MOUSE WITH ANALOG-SIGNAL SELECTOR BUTTON AND METHOD FOR SHIFTING ANALOG-SIGNAL SELECTOR BUTTON THEREOF

(71) Applicant: Danny Pai, New Taipei City (TW)

(72) Inventor: Danny Pai, New Taipei City (TW)

(21) Appl. No.: 15/195,249

(22) Filed: Jun. 28, 2016

(51) Int. Cl. G06F 3/038; G06F 3/0354; G06F 3/02

(52) U.S. Cl. CPC G06F 3/0383; G06F 3/0202; G06F 3/03543

(57) ABSTRACT

A mouse with an analog-signal selector button and a method for shifting the analog-signal selector button thereof are revealed. The analog-signal selector button includes a selector button and a selector button circuit. A height difference is equally divided into a number of N travels each of which is defined as a travel range when the selector button is pressed down to the deepest position from the original position. Then a number of N voltage ranges are generated according to the N travel ranges. A mouse circuit generates a number of N characteristic ranges according to the N travel ranges. The characteristic range is changed to a higher one when the selector button is pressed down from the nth travel range to the (n+1)th travel range, or changed to a lower one when the selector button is released from the (n+1)th travel range to the nth travel range.

### BACKGROUND OF THE INVENTION

The present invention relates to a mouse, especially to a mouse with an analog-signal selector button and a method for shifting the analog-signal selector button thereof.

A computer mouse is used for dimensional input, clicking on objects, scrolling images vertically or horizontally, etc. Take a mechanical mouse 10 shown in FIG. 1 as an example. The mechanical mouse 10 includes a top surface 11, a left button 12 on a front part of a left side of the top surface 11, a right button 13 on a front part of a right side of the top surface 11, and a central wheel 14 set between the left button 12 and the right button 13.

While using computers, users need to perform various operations such as open/or change a window, open/or change a home screen, restart the computer, search on internet etc. by pressing a plurality of buttons or their combinations at the same time. Thus it is inconvenient to use the computer for a long period. In order to solve the above problem, a computer mouse disposed with at least one hotkey is available on the market. The functions or properties of the hotkey can be defined according to users' needs. However, no matter the function or property the hotkey is defined, it is an on/off button and is electrically connected to the original circuit of the computer mouse. The function or property of the hotkey is preset in the circuit of the computer mouse (such as integrated circuit on a circuit board) by software or firmware design. The hotkey on the mouse is only use to turn on/off the specific function or property. The function/property of the hotkey defined can't be adjusted to different degrees in a real time manner. The changes of function/property in different degrees are characteristic ranges mentioned later in the present invention.

In a mouse with an analog-signal selector button according to the present invention, the selector button can be considered as a hotkey, providing real time modulation of various characteristic ranges instead of working as the on/off button.

The characteristic range means a specific property or function being modulated to various degrees, such as CPI (counts per inch) of the mouse, volume range, throttle response/speed range in racing games, shooting speed range in games, running speed range in games, etc. Take the CPI of the mouse as an example. The CPI, the number of steps the mouse will report when it moves one inch (about 25.4 mm), is used to indicate the resolution of the mouse. No matter the optical mouse or the laser mouse, a sensor therein shoots and record continuously during the movement of the mouse for checking and analyzing direction and distance of the movement. Thus the cursor on the screen is moved. The CPI means the number of recognizable coordinates a movement of one inch generates. Each coordinate is one dot. The higher the CPI value of the mouse, the more recognizable dots per a distance. Thus the mouse path is getting closer to the actual movement of the mouse. High CPI allows more information to be stored and the mouse reacts more accurate to a move the user makes. In the present invention, the higher the CPI, the faster the cursor moves with mouse movement.

There is a mouse with a CPI selector button available on the market. Yet the settings or modulation mechanisms of the CPI selector button have been set by manufacturers in advance before starting using the mouse. For example, the CPI value has four settings including 600, 800, 1000, and 1200 and a corresponding multi-stage/or circular adjustment button is arranged at the mouse for user to control the mouse. During the use of the conventional mouse, users can't adjust the speed of the cursor on the computer screen by the mouse in a real time manner. For example, users can't change the CPI instantly for precise aiming, clicking or fast movement while graphing or fighting in computer games.

However, the hotkeys with various functions such as multi-stage/or circular adjustment button of the mouse mentioned above are only an on/off button. Thus they are unable to meet user requirements while in use, especially in graphing, computer games or competitions. In order to solve the shortcoming of the conventional mouse in which various properties (such as cursor speed) are unable to be modulated in a real time manner, there is room for improvement and a need to provide a novel design of the mouse with the selector button.

### SUMMARY OF THE INVENTION

Therefore it is a primary object of the present invention to provide a mouse with an analog-signal selector button used for modulating a characteristic range to a required characteristic range in a real time manner.

In order to achieve the above object, a mouse according to the present invention is disposed with at least one analog-signal selector button. The analog-signal selector button includes a selector button and a selector button circuit connected to the selector button. The selector button is arranged at a surface of an outer case of the mouse so that users can use fingers to press the selector button or release the selector button in the opposite direction. A difference in height of the selector button is equally divided into a number of N travels each of which is defined as a travel range when the selector button is pressed down to the deepest position from the original position. The selector button is defined to be at an original travel range when the selector button is in the original position. The selector button is defined to be at the Nth travel range when the selector button is pressed down to the deepest position. The selector button is defined to be at the nth travel range when the selector button is pressed to move downward a number of n travels. Both n and N are natural numbers and 0≦n≦N. The selector button circuit is mounted in the mouse and is electrically connected to a mouse circuit (such as an integrated circuit mounted on a mouse circuit board). The selector button circuit makes the mouse circuit generate a number of N characteristic ranges from a lower one to a higher one according to the N travel ranges of the selector button. The characteristic ranges can be CPI ranges, volume ranges, throttle response/speed ranges in racing games, shooting speed ranges in games, running speed ranges in games, etc. The characteristic range (such as mouse CPI) is increased from a lower one to a higher one when the selector button is pressed down from the nth travel range to the (n+1)th travel range by the user. The lower characteristic range is corresponding to the nth travel range and higher characteristic range is corresponding to the (n+1)th travel range. The characteristic range (such as mouse CPI) is reduced from a higher one to a lower one when the selector button is released from the (n+1)th travel range to the nth travel range by the user. The higher characteristic range is corresponding to the (n+1)th travel range and the lower characteristic range is corresponding to the nth travel range.

The N characteristic ranges from a lower one to a higher one can be, but not limited to, CPI ranges for modulation of mouse CPI value, volume ranges for modulation of the volume, throttle response/speed ranges for modulation of throttle response/speed in racing games, shooting speed ranges for modulation of shooting speed in games, or running speed ranges for modulation of running speed in games.

The selector button includes a push-pull potentiometer/variable resistor or a photoelectric potentiometer/variable resistor. The selector button circuit makes the voltage input into an IO end of the mouse circuit have a number of N voltage ranges because the travel (resistance) is inversely proportional to the voltage when the selector button is pressed from the original position to the deepest position and the N travel ranges are formed. Then the N voltage ranges are converted into a number of N range digits correspondingly by analog-to-digital conversion function of the mouse circuit such as a microcontroller (MCU). Next the mouse circuit such as a central processing unit (CPU) performs analysis and processing according to the N range digits. Thereby the user can reach the required travel rage by pressing the selector button or releasing the selector button in the opposite direction. Thus the characteristic range can be adjusted to the required one corresponding to the required travel range in a real time manner.

It is another object of the present invention to provide a method for shifting an analog-signal selector button of a mouse with the analog-signal selector button having the following steps. Firstly dispose a selector button being pressed downward or released in the opposite direction by users' fingers. Then equally divide a difference in height between an original position of the selector button and the deepest position of the selector button being pressed into a number of N travels each of which is defined as a travel range. The selector button is defined to be at an original travel range when the selector button is in the original position. The selector button is defined to be at the Nth travel range when the selector button is pressed down and moved a number of N travels to be at the deepest position. When the selector button is pressed to move downward a number of n travels, the selector button is defined to be at the nth travel range. Both n and N are natural numbers and 0≦n≦N. Next let a voltage input into an IO end of a mouse circuit have a number of N voltage ranges corresponding to the N travels of the selector button because the travel is inversely proportional to the voltage. Then the N voltage ranges are converted into a number of N range digits correspondingly by analog-to-digital conversion function of the mouse circuit. At last a characteristic range is adjusted to the required one corresponding to an nth travel range in a real time manner when the selector button is pressed or released to the nth travel range by the users.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is a side view of the embodiment of FIG. 1 according to the present invention;

FIG. 3 is a schematic circuit diagram of an embodiment with a push-pull potentiometer according to the present invention;

FIG. 4 is a schematic circuit diagram of an embodiment with a photoelectric potentiometer according to the present invention;

FIG. 5 is a schematic drawing showing voltage ranges (V1, V2, V3, and V4) relative to the respective travel (four travels) of a selector button of an embodiment according to the present invention;

FIG. 6 is a flow chart showing modulation steps of an analog-signal selector button of an embodiment according to the present invention.

### DETAILED DESCRIPTION OF THE PREFERRED EMBODIMENTS

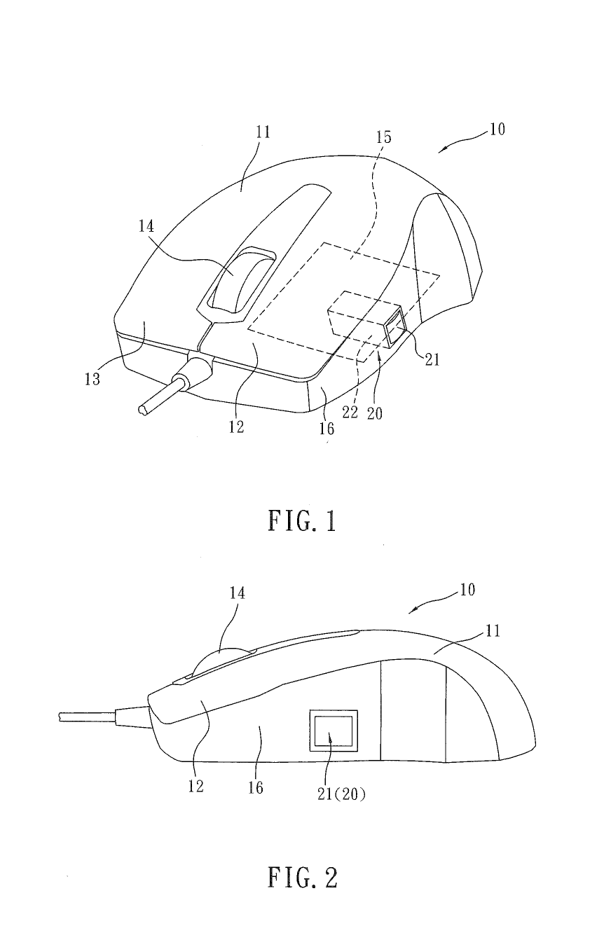

Refer to FIG. 1 and FIG. 2, a mouse 10 with an analog-signal selector button 20 according to the present invention has a structure similar to a general mouse (such as optical mouse or mechanical mouse) formed by a left button 12, a right button 13 and a central wheel 14 disposed on a front part of a top surface 11 thereof. Users can use the index finger, the middle finger, and the thumb to click the left button 12, the right button 13 and the central wheel 14 respectively.

The present invention features on that the mouse 10 includes at least one analog-signal selector button 20. The analog-signal selector button 20 consists of a selector button 21 and a selector button circuit 22 connected to the selector button 21 correspondingly.

The selector button 21 is arranged at a surface of an outer case of the mouse 10, such as a side surface 16 of the outer case of the mouse 10, as shown in FIG. 1 and FIG. 2. The user can use the finger (such as the thumb) to press the selector button 21 or release the selector button 21 in the opposite direction. The difference in height of the selector button 21 is equally divided into a number of N travels each of which is defined as a travel range when the selector button 21 is pressed down to the deepest position from the original position. The selector button 21 is defined to be at an original travel range when the selector button 21 is in the original position. The selector button 21 is defined to be at the Nth travel range when the selector button 21 is pressed down to the deepest position. When the selector button 21 is pressed to move downward a number of n travels, the selector button 21 is defined to be at the nth travel range. Both n and N are natural numbers and 0≦n≦N.

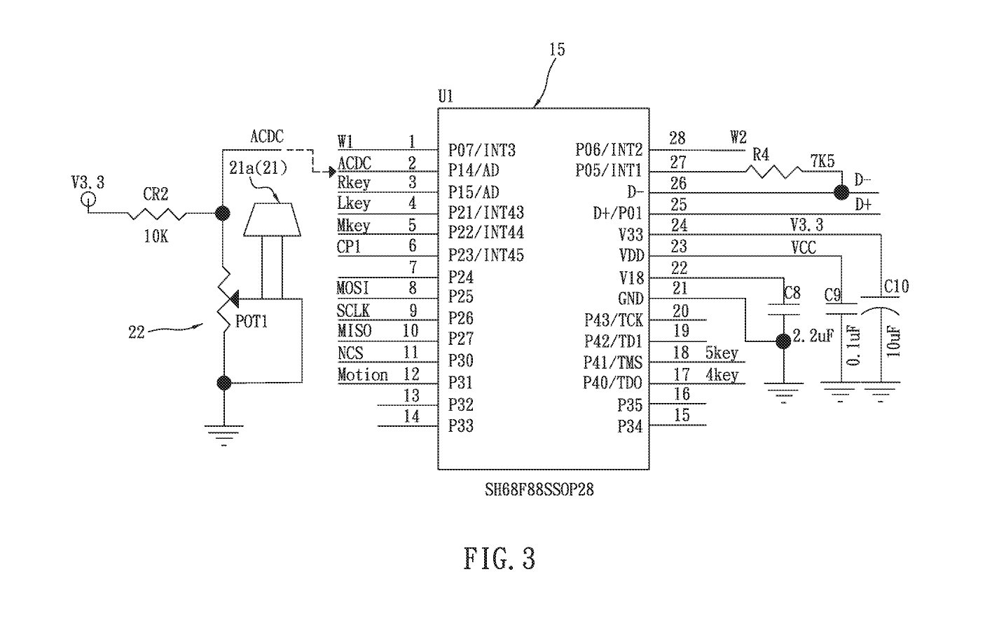

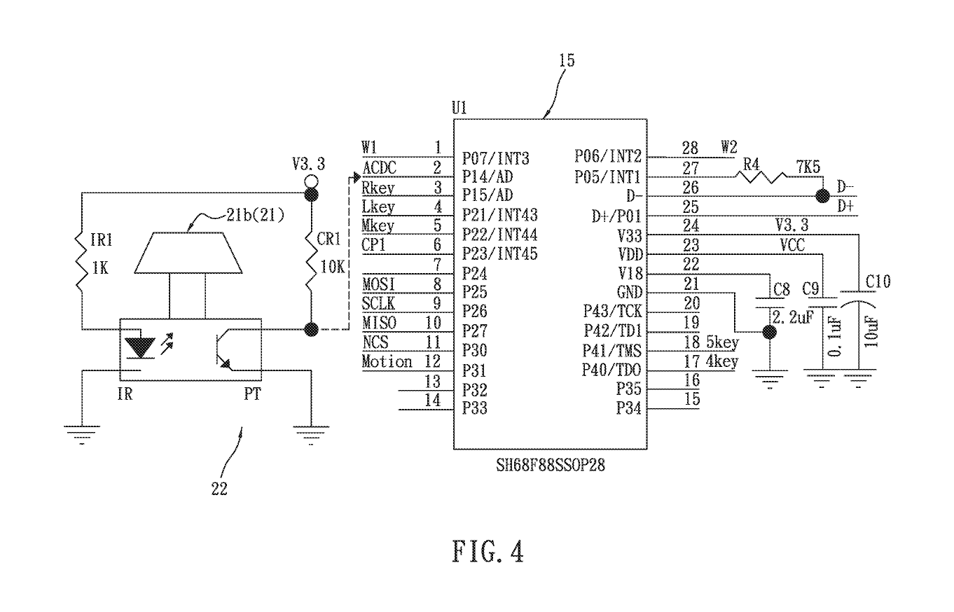

As to the selector button circuit 22, it is mounted in the mouse 10 and is electrically connected to a mouse circuit 15 that includes, but not limited to, a circuit board in the mouse 10 and an integrated circuit (IC) mounted on a circuit board, as shown in FIG. 3 and FIG. 4. The mouse circuit 15 generates a number of N characteristic ranges from a lower one to a higher one according to the N travel ranges of the selector button 21 ranging from the original travel range to the Nth travel range. The characteristic ranges herein mean a number of N ranges used for modulation of a certain characteristic (setting value) of the computer/mouse and able to be, but not limited to, CPI ranges for modulation of mouse CPI (counts per inch) values, volume ranges for modulation of the volume, throttle response/speed ranges for modulation of throttle response/speed in racing games, shooting speed ranges for modulation of shooting speed in games, running speed ranges for modulation of running speed in games, etc.

While in use, the characteristic range (such as mouse CPI) is changed from a lower travel range (such as a smaller CPI value) to a higher travel range (such as a larger CPI value) when the selector button 21 is pressed down from an nth travel range to a (n+1)th travel range by the user. The lower characteristic range is corresponding to the nth travel range and the higher characteristic range is corresponding to the (n+1)th travel range. The characteristic range (such as mouse CPI) is reduced from a higher travel range (such as a larger CPI value) to a lower travel range (such as a smaller CPI value) when the selector button 21 is released from the (n+1)th travel range to the nth travel range by the user. The higher characteristic range is corresponding to the (n+1)th travel range and the lower characteristic range is corresponding to the nth travel range.

The selector button 21 can be a potentiometer (variable resistor) such as a push-pull potentiometer 21a in FIG. 3, or a photoelectric potentiometer 21b in FIG. 4. Various voltages are formed by modulation of the variable resistor and applied through an IO end of the mouse circuit 15. Corresponding to the N travel ranges formed by the selector button 21 being pressed from the original position to the deepest position, the selector button circuit 22 makes the voltage input into the IO end (such as ACDC end) of the mouse circuit 15 have a number of N voltage ranges because the travel (resistance) is inversely proportional to the voltage. Then the N voltage ranges are converted into a number of N range digits correspondingly by the available components and functions of the mouse circuit 15 such as analog-to-digital conversion function of a microcontroller (MCU). Next a component of the mouse circuit 15 such as a central processing unit (CPU) performs analysis and processing according to the N range digits. Thereby the user can reach a required travel rage (such as the nth travel range) by pressing the selector button 21 or releasing the selector button 21 in the opposite direction. Thus the characteristic range can be adjusted to the required one (such as the nth characteristic range) corresponding to the required travel range in a real time manner.

Take the CPI value s of the mouse 10 as an example. When the user presses down the selector button 21 from an nth travel range to a (n+1)th travel range, the CPI value of the mouse 10 is increased from a lower CPI range corresponding to the nth travel range to a higher CPI range corresponding to the (n+1)th travel range. On the other hand, the CPI value of the mouse 10 is decreased from a higher CPI range corresponding to a (n+1)th travel range to a lower CPI range corresponding to an nth travel range when the user releases the selector button 21 from the (n+1)th travel range to the nth travel range.

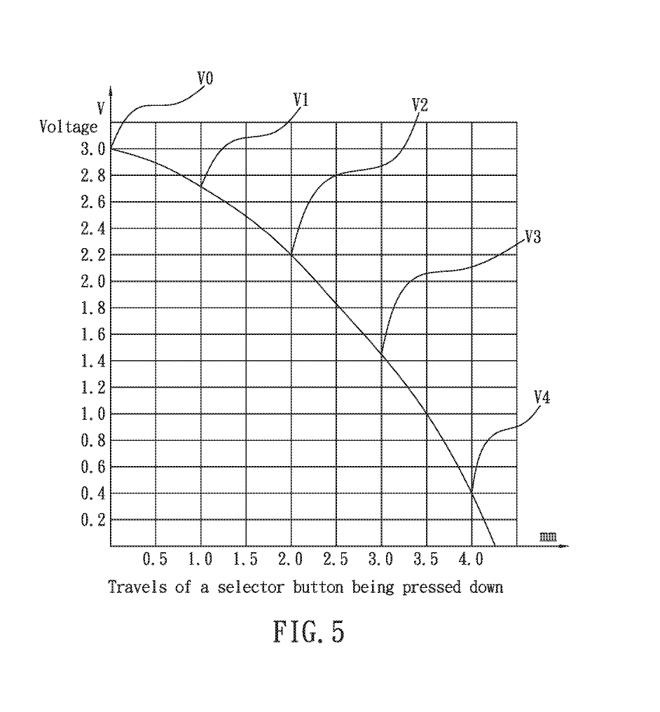

Refer to FIG. 5, the voltage input into an IO end (such as ACDC) of the mouse circuit 15 is changed from the original voltage range VO to the four different voltage ranges including V1, V2, V3, and V4 in turn (as shown in the Y axis) when the selector button 21 is pressed down to the deepest position from the original position (as shown in the X axis). Once the ACDC end of the mouse circuit 15 (as shown in FIG. 3 and FIG. 4) detects the voltage range (V1, V2, V3 or V4) from the IO end, the voltage range is converted into a range digit respectively. Then the mouse circuit 15 analyzes and processes the range digits respectively by the component such as a central processing unit (CPU) thereof. Thereby the user can adjust the characteristic range to a required characteristic range corresponding to an nth travel range (such as 1st-4th travel range) in a real time manner by pressing the selector button 21 or releasing the selector button 21 in the opposite direction to the nth travel range required. The user can also release the selector button 21 completely so that the selector button 21 is turned back to the original position. Thus the characteristic range is turned back to the original characteristic range along with the selector button 21 back to the original travel range.

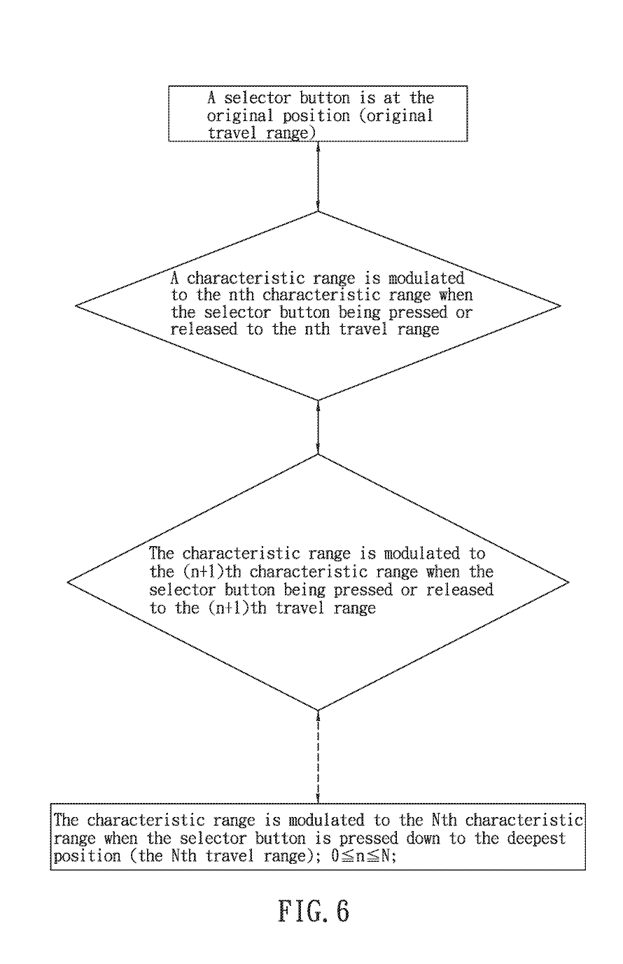

Refer to FIG. 6, the user can select a certain travel range freely by pressing or releasing the selector button 21 to move between the original position (the original travel range) and the deepest position (the Nth travel range). The certain travel range can be the original travel range, the Nth travel range, and one of the rest travel ranges such as the nth travel range or the (n+1)th travel range between the original travel range and the Nth travel range. Thus the characteristic range (such as the CPI value of the mouse 10) can be adjusted to a specific characteristic range corresponding to the certain travel range in a real-time manner while in use.

A method for shifting an analog-signal selector button of a mouse according to the present invention includes the following steps.

First arrange a selector button 21 that is pressed downward or released in the opposite direction by users' fingers.

Then divide a difference in height between an original position of the selector button 21 and the deepest position of the selector button 21 being pressed equally into a number of N travels each of which is defined as a travel range. The selector button 21 is defined to be at an original travel range when the selector button 21 is in the original position. The selector button 21 is defined to be at the

Nth travel range when the selector button 21 is pressed down and moved a number of N travels to be at the deepest position. When the selector button 21 is pressed to move downward a number of n travels, the selector button 21 is defined to be at the nth travel range. Both n and N are natural numbers and 0≦n≦N.

Next let a voltage being input into an IO end of a mouse circuit have a number of N voltage ranges corresponding to the N travels of the selector button 21 because the travel is inversely proportional to the voltage.

Then convert the N voltage ranges into a number of N range digits correspondingly by analog-to-digital conversion function of the mouse circuit.

At last, modulate a characteristic range to a required characteristic range corresponding to an nth travel range in a real time manner when the selector button 21 is pressed or released to the nth travel range by the users.

Compared with the prior arts, the mouse 10 with the analog-signal selector button 20 according to the present invention has the following advantages:

(1). The arrangement of the analog-signal selector button 20 doesn't affect original functions of the mouse 10. The analog-signal selector button 20 is used in combination with software or firmware of the mouse circuit 15 (such as circuit board and IC thereof). The cost of the mouse circuit 15 of the mouse 10 is not increased.

(2). The characteristic range is modulated in a real-time manner by user's finger (such as thumb) pressing or releasing the selector button 21. The operation of the mouse 10 is easy and the mouse 10 is used for efficiently.

(3). The vertical distance of the selector button 21 being pressed or released in the opposite direction is divided into a number of N travel ranges. A characteristic range is generated according to each travel range correspondingly. Thus the user can accelerate or decelerate conveniently by pressing or releasing one travel range gradually. Thus the product of computer game or gaining mouse is more competitive on the market.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A mouse with an analog-signal selector button comprising
a left button disposed on a front part of a top surface of the mouse and pressed by users' fingers,
a right button arranged at the front part of the top surface of the mouse and pressed by users' fingers, and
a central wheel set between the left button and the right button and rotated by users' fingers,
wherein the mouse further includes at least one analog-signal selector button; the analog-signal selector button having a selector button and a selector button circuit connected to the selector button; wherein the selector button is arranged at a surface of an outer case of the mouse so that users can use fingers to press the selector button or release the selector button in the opposite direction; a difference in height of the selector button is equally divided into a number of N travels each of which is defined as a travel range when the selector button is pressed down to the deepest position from the original position;
wherein the selector button is defined to be at an original travel range when the selector button is in the original position; the selector button is defined to be at the Nth travel range when the selector button is pressed down to the deepest position; the selector button is defined to be at the nth travel range when the selector button is pressed to move downward a number of n travels; wherein both n and N are natural numbers and 0≦n≦N;
wherein the selector button circuit is mounted in the mouse and is electrically connected to a mouse circuit; the selector button circuit makes the mouse circuit generate a number of N characteristic ranges from a lower one to a higher one according to the N travel ranges of the selector button;
wherein the characteristic range is increased from a lower range to a higher range when the selector button is pressed down from an nth travel range to a (n+1)th travel range by the user; wherein the characteristic range is reduced from a higher travel range to a lower travel range when the selector button is released from the (n+1)th travel range to the nth travel range by the user; thus the characteristic range is modulated in a real time manner by the user.

2. The device as claimed in claim 1, wherein the N characteristic ranges from a lower one to a higher one includes CPI ranges for modulation of mouse CPI value, volume ranges for modulation of the volume, throttle response/speed ranges for modulation of throttle response/speed in racing games, shooting speed ranges for modulation of shooting speed in games, and running speed ranges for modulation of running speed in games.

3. The device as claimed in claim 2, wherein the characteristic range is set as a CPI range of the mouse; the CPI range of the mouse is increased from a lower CPI range to a higher CPI range when the selector button is pressed down from an nth travel range to a (n+1)th travel range by the user while the lower CPI range is corresponding to the nth travel range and the higher CPI range is corresponding to the (n+1)th travel range; the CPI range of the mouse is reduced from a higher CPI range to a lower CPI range when the selector button is released from the (n+1)th travel range to the nth travel range by the user while the higher CPI range is corresponding to the (n+1)th travel range and the lower CPI range is corresponding to the nth travel range.

4. The device as claimed in claim 2, wherein the characteristic range is set as a throttle response range in racing games; a car in the racing game is accelerated from a lower throttle response range to a higher throttle response range when the selector button is pressed down from an nth travel range to a (n+1)th travel range by the user while the lower throttle response range is corresponding to the nth travel range and the higher throttle response range is corresponding to the (n+1)th travel range; the car in the racing game is slowed down from a higher throttle response range to a lower throttle response range when the selector button is released from the (n+1)th travel range to the nth travel range by the user while the higher throttle response range is corresponding to the (n+1)th travel range and the lower throttle response range is corresponding to the nth travel range

5. The device as claimed in claim 1, wherein the selector button includes a push-pull potentiometer or a photoelectric potentiometer.

6. The device as claimed in claim 5, wherein the selector button is a variable resistor; the selector button circuit makes a voltage input into an IO end of the mouse circuit have a number of N voltage ranges because the travel is inversely proportional to the voltage when the selector button is pressed from the original position to the deepest position and the N travel ranges are formed; then the N voltage ranges are converted into a number of N range digits correspondingly by analog-to-digital conversion function of the mouse circuit so that the mouse circuit performs analysis and processing according to the range digit corresponding to the selector button; thereby the user is able to reach a required travel range by pressing the selector button or releasing the selector button in the opposite direction; thus the characteristic range is modulated to a required characteristic range corresponding to the required travel range in a real time manner.

7. The device as claimed in claim 1, wherein the selector button is arranged at a side surface of the outer case of the mouse.

8. A method for shifting an analog-signal selector button of a mouse with the analog-signal selector button comprising the steps of:
disposing a selector button being pressed downward or released in the opposite direction by users' fingers;
dividing a difference in height between an original position of the selector button and the deepest position of the selector button being pressed equally into a number of N travels each of which is defined as a travel range; wherein the selector button is defined to be at an original travel range when the selector button is in the original position; the selector button is defined to be at the Nth travel range when the selector button is pressed down and moved a number of N travels to be at the deepest position; the selector button is defined to be at the nth travel range when the selector button is pressed to move downward a number of n travels; n and N are natural numbers and 0≦n≦N;
letting a voltage being input into an IO end of a mouse circuit have a number of N voltage ranges corresponding to the N travels of the selector button because the travel is inversely proportional to the voltage;
converting the N voltage ranges into a number of N range digits correspondingly by analog-to-digital conversion function of the mouse circuit; and
modulating a characteristic range to a required characteristic range corresponding to an nth travel range in a real time manner then the selector button is pressed or released to the nth travel range by the users.
